(19) United States
(12) Patent Application Publication
(10) Pub. No.: US 2014/0142824 A1
(43) Pub. Date: May 22, 2014

(54) APPARATUS AND METHOD FOR CONTROLLING DAMPER CLUTCH OF AUTOMATIC TRANSMISSION VEHICLE

(71) Applicant: Hyundai Motor Company, Seoul (KR)

(72) Inventor: Jong Eek Kim, Seoul (KR)

(73) Assignee: Hyundai Motor Company, Seoul (KR)

(21) Appl. No.: 14/057,957

(22) Filed: Oct. 18, 2013

(30) Foreign Application Priority Data
Nov. 16, 2012 (KR) 10-2012-0130280

(51) Int. Cl. F16D 48/06

(52) U.S. Cl. CPC F16D 48/06
USPC 701/68

(57) ABSTRACT

A method of controlling a damper clutch of a turbocharger mounted automatic transmission vehicle secures stable boost pressure to provide accelerating feeling is disclosed. The method may include detecting driving information from a turbocharger mounted vehicle to determine whether lock up conditions of a damper clutch are satisfied, determining an engine load by a gear shift stage and an engine speed when the lock up conditions of the damper clutch are satisfied, detecting supplied boost pressure to determine whether conditions of the engine load are satisfied, and canceling the lock up of the damper clutch for accelerating feeling when the boost pressure does not satisfy the conditions of the engine load.

### CROSS-REFERENCE TO RELATED APPLICATION

The present application claims priority of Korean Patent Application Number 10-2012-0130280 filed Nov. 16, 2012, the entire contents of which application is incorporated herein for all purposes by this reference.

### BACKGROUND OF INVENTION

1. Field of Invention

The present invention relates to an automatic transmission vehicle. More particularly, the present invention relates to an apparatus and a method for controlling a damper clutch of an automatic transmission vehicle capable of securing stable boost pressure in an automatic transmission vehicle to which a turbocharger is applied to provide accelerating feeling.

2. Description of Related Art

Due to increased consumer demand for convenience for a vehicle, use of an automatic transmission is remarkably increasing. However, since a torque converter used for the automatic transmission has low efficiency, the automatic transmission is much more disadvantageous than a manual transmission in terms of fuel consumption.

Therefore, in order to provide convenience of the automatic transmission and efficiency of the manual transmission, a damper clutch for locking up a pump shaft and a turbine shaft of the torque converter is applied.

The damper clutch locks up the pump shaft and the turbine shaft of the torque converter in a predetermined driving region to improve efficiency of power without deteriorating fuel consumption by power loss generated by a difference in a rotation speed.

When a control in which the damper clutch locks up the pump shaft and the turbine shaft is performed, it is possible to obtain high efficiency like the manual transmission so that fuel consumption may be improved. However, a torque multiplication operation of the torque converter may not be used so that accelerating feeling may be deteriorated.

In the automatic transmission, a damper clutch operation map for performing lock up and non-lock up of the damper clutch is predetermined by a turbine speed and a position value of an accelerator pedal and power on conditions and power off conditions are distinguished from each other.

The damper clutch is locked up when predetermined conditions are satisfied in a power on region formed of a map and lock-up is canceled when predetermined cancel conditions are satisfied to the contrary.

Conditions of an operation map predetermined to control lock up and non-lock up of the damper clutch slightly vary with manufacturing companies of a transmission management system (TMS), however, are similar.

For example, the lock up conditions of the damper clutch may be predetermined to satisfy all of the following conditions.

The position of the accelerator pedal and the turbine speed must satisfy a predetermined condition, oil temperature of the automatic transmission and a current gear shift stage must satisfy a predetermined condition, a gradient of a driving road must satisfy a predetermined condition, amounts of change and slip of line pressure must satisfy a predetermined condition, an engine is not to be in a warm up mode and a slip lock up prohibiting mode, a throttle valve open rate by operation of the accelerator pedal must be no more than a predetermined change rate, and lock up entry delay time must satisfy a predetermined condition.

Any one of the above-described lock up conditions of the damper clutch is not satisfied, the lock up state is canceled.

However, when the damper clutch is locked up in a range where turbo lag is generated by a gasoline engine in which a turbocharger is mounted due to low exhaust pressure so that boost pressure is slowly increased, an output of the engine is deteriorated so that accelerating feeling is deteriorated.

That is, since an increase in the boost pressure is delayed by the turbo lag and the output of the engine is deteriorated so that the accelerating feeling is not secured, accelerating will of a driver may not be fully reflected.

The turbo lag means time spent on opening a throttle valve and delay time spent until the turbocharger provides more power.

That is, the turbo lag means time spent on a turbine in an idle state reaching a boost speed and time spent on an intercooler in a vacuum state being filled so that pressure is generated.

Exemplars of the prior art include Registered Patent Publication No. 10-0726732 (2007 Jun. 4) and Registered Patent Publication No. 10-0427877 (2004 Apr. 8).

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for an apparatus and a method for controlling a damper clutch of an automatic transmission vehicle capable of controlling lock up or canceling of lock up of a damper clutch in accordance with conditions of an engine load and boost pressure in an automatic transmission vehicle to which a turbocharger is applied to secure stable boost pressure and to provide stable accelerating feeling.

An apparatus for controlling a damper clutch of an automatic transmission vehicle according to various aspects of the present invention may include a driving information detecting unit for detecting overall driving information of a vehicle, a boost pressure detecting unit for detecting boost pressure supplied to a combustion chamber in accordance with an operation of a turbocharger, an actuator for locking up a damper clutch and canceling lock up of a damper clutch, and a controller for determining conditions of an engine load when driving information provided by the driving information detecting unit satisfies lock up conditions of the damper clutch predetermined by a map and for canceling the lock up of the damper clutch when the boost pressure does not satisfy the conditions of the engine load.

The driving information detecting unit may include information such as a position of an accelerator pedal, a turbine speed, oil temperature of a transmission, a gear shift stage, a gradient, line pressure, a slip amount, coolant temperature, and an engine speed.

The controller may determine conditions of an engine load by the gear shift stage and the engine speed.

The controller may lock up the damper clutch by the actuator when the driving information satisfies the lock up conditions of the damper clutch predetermined by the map and the boost pressure satisfies the conditions of the engine load.

A method of controlling a damper clutch of an automatic transmission according to various aspects of the present invention may include detecting driving information from a turbocharger mounted vehicle to determine whether lock up conditions of a damper clutch are satisfied, determining an engine load by a gear shift stage and an engine speed when the lock up conditions of the damper clutch are satisfied, detecting supplied boost pressure to determine whether conditions of the engine load are satisfied, and canceling the lock up of the damper clutch for accelerating feeling when the boost pressure does not satisfy the conditions of the engine load.

The damper clutch may be locked up when the lock up conditions of the damper clutch are satisfied and the boost pressure satisfies the conditions of the engine load.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view schematically illustrating an exemplary apparatus for controlling a damper clutch of an automatic transmission according to the present invention.

FIG. 2 is a flowchart illustrating exemplary processes of controlling a damper clutch of an automatic transmission according to the present invention.

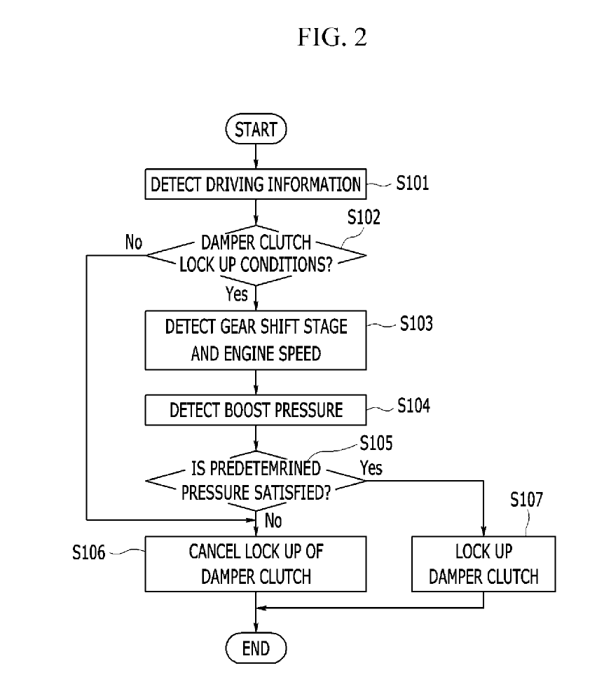

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In order to clearly describe the present invention, parts that are not related to description are omitted and the same or similar constituent elements are denoted by the same reference numerals throughout the entire specification.

In addition, since the constituent elements are arbitrarily illustrated in the drawings for convenience sake, the present invention is not necessarily limited to the drawings.

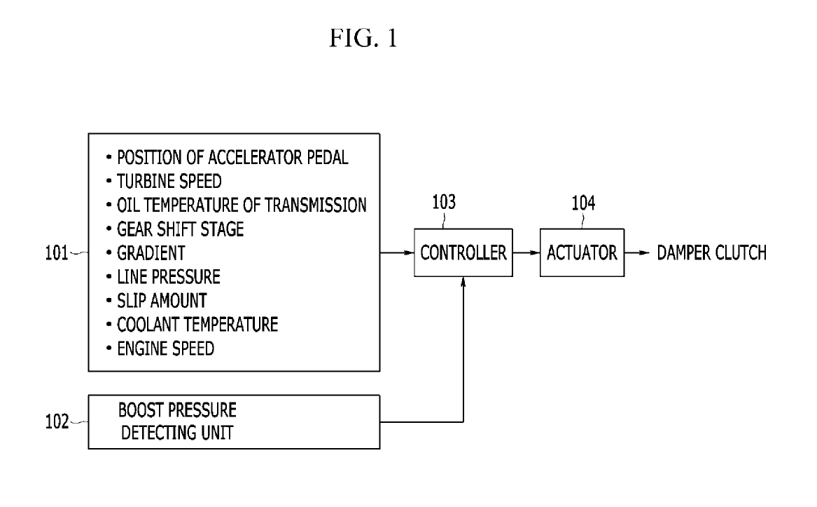

FIG. 1 is a view schematically illustrating an apparatus for controlling a damper clutch of an automatic transmission according to various embodiments of the present invention.

Referring to FIG. 1, the damper clutch controlling apparatus according to the present invention includes a driving information detecting unit 101, a boost pressure detecting unit 102, a controller 103, and an actuator 104.

The driving information detecting unit 101 detects overall driving information including a position of an accelerator pedal operated by a driver, a turbine speed, oil temperature of a transmission, a gear shift stage, a gradient, line pressure, a slip amount, coolant temperature, and an engine speed to provide the detected driving information to the controller 103.

The boost pressure detecting unit 102 detects boost pressure supplied to a combustion chamber in accordance with an operation of a turbocharger to provide information on the boost pressure to the controller 103.

The controller 103 analyzes the information provided by the driving information detecting unit 101 to determine conditions of an engine load in accordance with the gear shift stage and the engine speed when lock up conditions of a damper clutch predetermined by a map are satisfied and to control the lock up of the damper clutch when the boost pressure satisfies the conditions of the engine load.

However, the control portion 103 cancels the lock up of the damper clutch so that stable boost pressure may be secured when the driving information satisfies the lock up conditions of the damper clutch and the boost pressure does not satisfy the conditions of the engine load.

Therefore, stable responsiveness to accelerating demand of a driver may be provided.

A map for the controller 103 to lock up the damper clutch and to cancel the lock up of the damper clutch is predetermined, for example, as follows.

The position of the accelerator pedal and the turbine speed must satisfy a predetermined condition, oil temperature of the automatic transmission and a current gear shift stage must satisfy a predetermined condition, a gradient of a driving road must satisfy a predetermined condition, amounts of change and slip of line pressure must satisfy a predetermined condition, an engine is not to be in a warm up mode and a slip lock up prohibiting mode, a throttle valve open rate by operation of the accelerator pedal must be no more than a predetermined change rate, and lock up entry delay time must satisfy a predetermined condition.

Any one of the above-described lock up conditions of the damper clutch is not satisfied, the lock up state is canceled.

The actuator 104 locks up the damper clutch and cancels the lock up of the damper clutch in accordance with a control signal applied by the controller 103.

The actuator 104 may be formed of a solenoid valve.

Operations of the damper clutch controlling apparatus according to the present invention having the above-described functions are performed as follows.

When a turbocharger mounted vehicle to which an automatic transmission according to the present invention is applied is driven, the controller 103 detects overall driving information including a position of an accelerator pedal operated by a driver, a turbine speed, oil temperature of a transmission, a gear shift stage, a gradient, line pressure, a slip amount, coolant temperature, and an engine speed by the driving information detecting unit 101 S101.

The controller 103 analyzes the driving information detected in S101 to determine whether lock up conditions of the damper clutch predetermined by a map are satisfied S102.

In the lock up conditions of the damper clutch, the position of the accelerator pedal and the turbine speed must satisfy a predetermined condition, oil temperature of the automatic transmission and a current gear shift stage must satisfy a predetermined condition, a gradient of a driving road must satisfy a predetermined condition, amounts of change and slip of line pressure must satisfy a predetermined condition, an engine is not to be in a warm up mode and a slip lock up prohibiting mode, a throttle valve open rate by operation of the accelerator pedal must be no more than a predetermined change rate, and lock up entry delay time must satisfy a predetermined condition.

When it is determined in S102 that the driving information satisfies the lock up conditions of the damper clutch, the controller 103 determines the conditions of the engine load in accordance with the gear shift stage and the engine speed S103 to detect the boost pressure supplied to the combustion chamber in accordance with the operation of the turbocharger by the boost pressure detecting unit 102 S104.

The controller 103 determines whether the boost pressure detected in S104 satisfies the conditions of the engine load S105.

When it is determined in S105 that the boost pressure satisfies the conditions of the engine load, the controller 103 operates the damper clutch by the actuator 104 to lock up the damper clutch S107.

However, when it is determined in S105 that the boost pressure does not satisfy the conditions of the engine load, the controller 103 cancels the lock up of the damper clutch by the actuator 104 so that stable boost pressure may be secured S106.

The boost pressure in accordance with the engine load may be predetermined as illustrated in Table 1.

TABLE 1

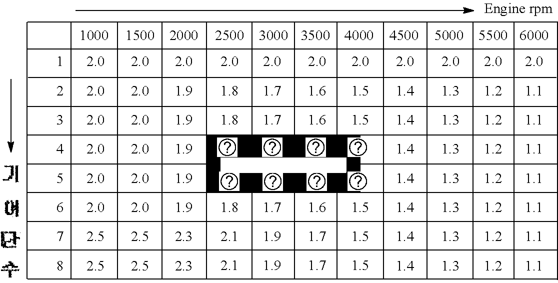

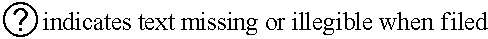

Therefore, stable responsiveness to accelerating demand of a driver may be provided.

As described above, according to the present invention, when the turbocharger mounted automatic transmission vehicle is in a condition disadvantageous to the accelerating feeling, the lock up of the damper clutch is avoided through TMS logic to secure stable boost pressure and accelerating responsiveness.

In the damper clutch controlling apparatus according to the present invention, the lock up of the damper clutch is canceled in a region where the boost pressure of the turbocharger is insufficient so that the torque multiplication operation of the torque converter is used. Therefore, a driving torque is increased so that responsiveness to the accelerating will of the driver may be improved.

In the turbocharger mounted automatic transmission vehicle according to the present invention, the lock up of the damper clutch is canceled in a region where the driving torque is insufficient and an engine torque must be rapidly increased so that stable accelerating feeling may be provided.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling a damper clutch of an automatic transmission, comprising:
a driving information unit detecting overall driving information of a vehicle;
a boost pressure unit detecting boost pressure supplied to a combustion chamber in accordance with an operation of a turbocharger;
an actuator for locking up a damper clutch and canceling lock up of the damper clutch; and
a controller for determining conditions of an engine load when driving information provided by the driving information unit satisfies lock up conditions of the damper clutch predetermined by a map and for canceling the lock up of the damper clutch when the boost pressure does not satisfy the conditions of the engine load.

2. The damper clutch controlling apparatus of claim 1, wherein the driving information unit comprises information including a position of an accelerator pedal, a turbine speed, oil temperature of a transmission, a gear shift stage, a gradient, line pressure, a slip amount, coolant temperature, or an engine speed.

3. The damper clutch controlling apparatus of claim 1, wherein the controller determines conditions of an engine load by the gear shift stage and the engine speed.

4. The damper clutch controlling apparatus of claim 1, wherein the controller locks up the damper clutch by the actuator when the driving information satisfies the lock up conditions of the damper clutch predetermined by the map and the boost pressure satisfies the conditions of the engine load.

5. A method of controlling a damper clutch of an automatic transmission, comprising:
detecting driving information from a turbocharger mounted vehicle to determine whether lock up conditions of a damper clutch are satisfied;
determining an engine load by a gear shift stage and an engine speed when the lock up conditions of the damper clutch are satisfied;
detecting supplied boost pressure to determine whether conditions of the engine load are satisfied; and
canceling the lock up of the damper clutch for accelerating feeling when the boost pressure does not satisfy the conditions of the engine load.

6. The method of claim 5, wherein the damper clutch is locked up when the lock up conditions of the damper clutch are satisfied and the boost pressure satisfies the conditions of the engine load.

7. An apparatus for controlling a damper clutch of an automatic transmission, comprising:
a boost pressure unit for detecting boost pressure supplied by an operation of a turbocharger; and
a control unit for operating an actuator in accordance with driving information to control lock up of a damper clutch,
wherein the control unit controls the damper clutch by claim 5 in accordance with a predetermined program.
